(19) United States
(12) Patent Application Publication
(10) Pub. No.: US 2009/0142417 A1
(43) Pub. Date: Jun. 4, 2009

(54) PROCESS FOR THE PREPARATION OF CONCENTRATED SOLUTIONS OF STABILIZED HYPOBROMITES

(75) Inventors: Theodor Morel Fishler, Haifa (IL); David Feldman, Haifa (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: BROMINE COMPOUNDS LTD., Beer-Sheva (IL)

(21) Appl. No.: 12/353,401

(22) Filed: Jan. 14, 2009

Related U.S. Application Data
(63) Continuation-in-part of application No. 10/513,512, filed on Jun. 20, 2005, now abandoned.

(30) Foreign Application Priority Data
May 6, 2002 (IL) 149499

(51) Int. Cl. A01N 59/00; A01P 1/00

(52) U.S. Cl. 424/722

(57) ABSTRACT

The invention is a process for the preparation of stabilized aqueous solutions of alkali hypobromites at low temperatures, which comprises reacting a concentrated alkali hydroxide aqueous solution with bromine, and adding to the reaction product, which is a non-stabilized solution, an aqueous solution of a sulfamic compound, such as sodium sulfamate, thus forming a stabilized alkali hypobromite solution.

### CLAIM OF PRIORITY

This application is a continuation-in-part application of U.S. patent application Ser. No. 10/513,512 having a 371(c) date of Jun. 20, 2005; which is a 371 of PCT/IL2003/000363, filed on May 5, 2003; which claims priority to Israeli patent application serial number 149499, filed on May 6, 2002.

### FIELD OF THE INVENTION

This invention relates to a method for the preparation of concentrated solutions of stabilized hypobromites. This invention also relates to stabilized solutions of hypobromites obtained by the process of this invention.

### BACKGROUND OF THE INVENTION

Hypobromous acid is one of the most potent sanitizers among the oxidizing halogenated compounds. Since it is a weaker acid than hypochlorous acid (pK=8.8 at 25° C.), it is predominant at pH higher than 9.

Alkaline hypobromites can be prepared at low temperature, with good yield, if an excess of hydroxide is provided. A supersaturated solution can be prepared at 10° C., if 90% of the equivalent amount of bromine is fed to a 10 N solution of NaOH or KOH. The pentahydrate NaBrO.5H₂O begins to precipitate at −3° C., and keeps precipitating at lower temperatures, while the heptahydrate begins to precipitate at −7° C., and keeps precipitating at lower temperatures. However, the precipitation is slow. This mode of operation enables the preparation of MOBr solution (M=Na, K), but these are not stable enough for practical and commercial applications. Concentration increase of the MOBr has a beneficial effect on the stability because of the simultaneous decrease of water concentration.

Hypobromites, e.g. sodium hypobromite, can also be prepared from the reaction of bromides with an oxidant, e.g., chlorine or hypochlorite. The reaction with hypochlorite has the disadvantage of yielding equivalent amounts of NaOBr and NaCl. Since the NaOCl solutions themselves contain NaCl in equivalent amount with NaOCl, and mostly contain at most 15.8 wt % NaOCl, the obtainable concentration of NaOBr is relatively low.

The strong oxidizing potential of the hydrobromous acid and hypobromites made them very difficult to stabilize. Several classes of stabilizers, among them amides, amines, sulfonamides, melamine, sulfamic acid, cyanuric acid, and hydantoins, have been suggested in the prior art. However, amides and amines are generally oxidized by the hypobromites. Urea is decomposed down to nitrogen and other amides are transformed to amines that in turn can be oxidized to nitrogen.

Sulfamic acid and its salts have been mentioned as stabilizers, being stable to the attack of hypochlorous and hypobromous acids. The latter react at low temperatures with the alkali salts of sulfamic acid, affording chloro- and bromoamidosulfonates XHN-SO₃M. However, some strong oxidants, among them chlorine and bromine, can attack the NH₂ function liberating nitrogen.

U.S. Pat. No. 5,683,654 discloses a process which comprises preparing an aqueous solution of unstabilized alkali or alkaline earth metal hypobromite by mixing and reacting the corresponding hypochlorite with a water-soluble bromide ion source and stabilizing the result with an aqueous solution of an alkali metal sulfamate. U.S. Pat. Nos. 5,795,487 and 5,942,126 disclose essentially the same process.

U.S. Pat. No. 6,037,318 describes a process for the manufacture of alkaline bleaching compositions which comprises three steps: a) admixing a source of sodium hypochlorite and an amino compound which may be sulfamic acid, to form a pre-bromine admixture; b) adding to the mixture a source of bromine; and c) adjusting the pH of the resulting mixture to at least 13. However, since hypochlorite solutions generally contain chlorides in an equivalent amount with hypochlorites, the resulting mixtures contain large amounts of sodium chloride. Further, since the stabilizer, e.g., sulfamic acid, and the hypochlorite are mixed before the addition of a bromine source, the efficiency of the stabilizer is decreased, because it reacts with the hypochlorite. The stabilized solution has a low NaOBr concentration because of the low concentration of the starting NaOCl solution.

DE 3398850 discloses stabilizing solutions of sodium hypochlorite with a stabilizer which may be the sodium salt of amidosulfonic acid. It does not teach the preparation of hypobromite solutions.

U.S. Pat. No. 6,068,861 describes a process of making a concentrated liquid biocide formulation, in which bromine chloride and an alkali metal salt of sulfamic acid are mixed, Bromine chloride is difficult to handle and tends to dissociate to bromine and chlorine. It is not a commercial product and must be manufactured by using special skills and expensive installations for keeping it in liquid phase under pressure.

It is a purpose of this invention to provide a method for obtaining stabilized solutions which contain high concentrations of alkali hypobromites.

It is another purpose of the invention to provide such solutions in which bromine is fed as such and not through a more complex source of bromine.

It is a further purpose of this invention to provide such a process that provides hypobromite solutions having an amount of active halogen, expressed as available chlorine, that is higher than that of any solution prepared according to the prior art.

It is a still further purpose of this invention to provide a sanitation method for bodies of water, such as industrial water in cooling towers, pulp and paper waste and the like, in the pH range of 5-10, by feeding the hypobromite solution prepared according to the process of the invention, so that the proper active HOBr concentration (expressed as available chlorine) is achieved.

Other purposes and advantages of the invention will appear as the description proceeds.

### SUMMARY OF THE INVENTION

The process of the invention comprises the following steps:
a) contacting a concentrated alkali hydroxide aqueous solution with bromine, in a hydroxide-bromine equivalent ratio that is from 2:1 to 3:1 and is preferably not less than 2.2:1;
b) allowing the mixture to react at a temperature from −5° C. to +10° C., preferably 0±5° C.;
c) adding to the product of said reaction, which comprises unstabilized alkali hypobromite, a concentrated aqueous solution of a sulfamic compound, chosen from the group consisting of sulfamic acid and soluble sulfamic acid salts, so that a molar ratio of said acid or salt to hypobromite is from 1:1 to 2:1 and preferably about 1.5:1, at a temperature from −5° C. to +10° C. and preferably 0±5° C., whereby to form stabilized hypobromite solution.

The preferred sulfamic compound is sodium sulfamate.

The aqueous solution obtained is free from alkali chloride, It contains, depending on the concentration of the sulfamic acid or sulfamate solution, an amount of active halogen, expressed as available chlorine, from 7 to 11.5 wt %, based on the weight of the whole solution and determined by jodometric titration, higher than that of any comparable solution prepared according to the prior art. The solution prepared by the process defined hereinbefore, has a higher stability than the solution of the prior art, as will be specified later on.

The preferred alkali hydroxide is sodium hydroxide.

The solution according to the invention contains alkali bromide, preferably e.g. sodium bromide. Its alkali, e.g. sodium, chloride content is less than 1 wt % and its amount of available halogen, expressed as chlorine, is at least 7%. It further contains from 13 to 19 wt % of sulfamate anion. Said solution is an aspect of the present invention.

In a preferred embodiment of the invention, a process for preparing a stabilized hypobromite solution is provided, as well as such a stabilized solution, comprising an amount of active halogen in said stabilized solution, expressed as available chlorine, of at least 7%. A stabilized sodium hypobromite solution according to the invention may contain, for example, at least 12 wt % of sodium hypobromite, at least 10.4 wt % of sodium bromide, less than 1 wt % of sodium chloride, and from 17 to 21 wt % of sodium sulfamate, and may have an amount of active halogen, expressed as available chlorine, of at least 7%.

Obviously, as being clear for anybody skilled in the art, these concentrations are given for a 100% yield. Again, as obviously known by anybody skilled in the art, somewhat lower yields are obtained, depending on the ability of the operator and precision of temperature and weight control. The yields actually achieved, however, are not less than 99.5% and usually higher than this.

### DETAILED DESCRIPTION OF PREFERRED EMBODIMENTS

The following examples illustrate the invention without being limitative. The percentages given are all by weight.

### Example 1

A concentrated hypobromite solution was prepared by contacting, under vigorous stirring, 532.5 g of a concentrated aqueous NaOH solution (49.2 wt %) with 480 g bromine, added gradually so that the temperature was maintained at 0±5° C. The NaOH/bromine molar ratio was 2.2:1. A clear, dark yellow solution of unstabilized sodium hypobromite was obtained, which contained 35.1 wt % NaOBr and 30.4 wt % NaBr. In spite of the very high concentration and low temperature, no precipitation occurred due to the very high solubility of NaBr.

To that hypobromite solution was added gradually, in order to keep the temperature between −5 to 10° C., preferably 0-5° C., an aqueous solution of sodium sulfamate prepared by gradually adding at room temperature 401.7 g of an aqueous 49.2 wt % NaOH solution to 836.5 g of an aqueous slurry composed of 436.5 g sulfamic acid and 400 g water. The molar ratio between Na sulfamate and NaOBr was 1.5:1. The resulting solution (2250.7 g) contained 357 g (15.9 wt %) stabilized NaOBr, 309 g (13.7 wt %) NaBr (one mole per mole of NaOBr), and 535.5 g (23.8 wt %) of sodium sulfamate. The amount of active halogen, expressed as available chlorine, determined by iodometry, was 9.5%, higher than in any solution prepared from hypochlorite and NaBr according to the prior art.

### Example 2

A preferred formulation was prepared by a sequence of operations similar to that in Example 1, except that the first stage—preparation of the non-stabilized NaOBr aqueous solution—was carried out in the presence of 494 g of water mixed with the caustic solution. To this mixture, 480 g bromine was added while keeping the temperature indicated in the previous example. The non stabilized NaOBr solution contained 357 g (23.7 wt %) of stabilized NaOBr and 309 g (20.5 wt %) of NaBr. This solution was stabilized as described in the Example 1, with a similarly prepared sodium sulfamate solution. The final, stabilized solution contained 13 wt % stabilized NaOBr, 11.2% NaBr, and 19.5% sodium sulfamate. The same sodium sulfamate to NaOBr ratio (1.5:1) was achieved. The active halogen content, expressed as available chlorine, was 7.7%.

While examples have been given by way of illustration, it should be understood that the invention can be carried out with many modifications, variations and adaptations, without departing from its spirit or exceeding the scope of the claims.

1. A process for the preparation of stabilized aqueous solutions of hypobromites, comprising the steps of:
a) contacting a concentrated alkali hydroxide aqueous solution with bromine, in a hydroxide-bromine equivalent ratio from 2:1 to 3:1;
b) allowing the mixture to react at a temperature from −5 to 10° C.; and
c) adding to the product of said reaction, which comprises unstabilized alkali hypobromite, an aqueous solution of a sulfamic compound, selected from the group consisting of sulfamic acid and soluble sulfamic acid salts, at a molar ratio of sulfamate to hypobromite from 1:1 to 2:1, at a temperature between −5 to 10° C., whereby to form stabilized hypobromite solution.

2. A process according to claim 1, wherein the sulfamic compound is sodium sulfamate

3. A process according to claim 1, wherein the hydroxide-bromine molar ratio is not less than 2.2:1.

4. A process according to claim 1, wherein the mixture of alkali hydroxide solution with bromine is allowed to react at a temperature of 0±5° C.

5. A process according to claim 1, wherein the sulfamic compound solution is added to the reaction product comprising unstabilized alkali hypobromite, at a molar ratio of sulfamic compound to hypobromite of about 1.5:1 and at a temperature of 0±5° C.

6. A process according to claim 1, wherein said stabilized hypobromite solution has an amount of active halogen, expressed as available chlorine, of at least 7%.

7. A stabilized sodium hypobromite solution containing at least 12 Wt % of sodium hypobromite, at least 10.4 wt % of sodium bromide, less than 1 wt % of sodium chloride, and from 17 to 21 wt % of sodium sulfamate content, and having an amount of active halogen, expressed as available chlorine, of at least 7%.

8. A stabilized sodium hypobromite solution according to claim 1 useful for disinfection of industrial water in cooling towers, pulp and paper wastes and similar.
